(19) United States
(12) Patent Application Publication
(10) Pub. No.: US 2012/0037009 A1
(43) Pub. Date: Feb. 16, 2012

(54) BOILER FOR A MACHINE FOR PREPARING BEVERAGES

(75) Inventors: Jean-Pierre Blanc, Nice (FR); Alain Goering, Nice (FR)

(73) Assignee: COMPAGNIE MEDITERRANEENNE DES CAFES, Carros (FR)

(21) Appl. No.: 13/265,433

(22) PCT Filed: Apr. 20, 2010
(86) PCT No.: PCT/EP2010/055149

§ 371 Date: Oct. 20, 2011

(30) Foreign Application Priority Data
Apr. 21, 2009 (FR) 0952614

(51) Int. Cl. A47J 31/54; F22B 1/28

(52) U.S. Cl. 99/302 R; 392/401

(57) ABSTRACT

A boiler for a machine for preparing beverages, wherein a fluid is brought to a pressure of at least 8 bars, including at least one diffuser (1) having a first wall (2) to be placed in contact with the fluid to be heated, a second wall (3) opposite the first wall (2) and provided with at least one heating element, at least one body (5) defining, together with the first wall (2) of the diffuser (1), at least one heating chamber, wherein the heating element is a screen-printed or photoengraved resistor. The boiler has a deformation chamber (7). The chamber is arranged such that, when subjected to the pressure in the heating chamber, the diffuser (1) elastically deforms in the deformation chamber (7) so as at least partially to absorb the pressure force.

The present invention concerns a boiler for use in a machine for making hot beverages capable of heating a fluid brought up to a relatively high pressure. It will find an application in particular on coffee machine boilers.

In known technology, the boilers used in machines for preparing hot beverages consist of a metal block forming a heating volume within which is embedded a heating resistance. The shortcoming of these boilers is that they have high thermal inertia and require a relatively long time for the liquid to be heated. Moreover, making these boilers involves a high cost in materials.

In order to quickly make a hot drink, boilers capable of increasing the temperature of liquid used to prepare the drink quickly have already been proposed. The boilers generally include a screen-printed resistance forming a heating element associated with a diffuser.

However, these boilers are not used to prepare beverages when the liquid has to be brought up to a considerable pressure. Indeed, they cannot withstand the relatively high pressures of above 8 bars while remaining small and low cost. In fact, the preparation of certain drinks such as espresso coffee requires that the liquid be brought to a pressure of roughly 16 bars in order to extract the coffee.

Therefore, there is a consistent need to propose a boiler for use on a machine for preparing hot drinks that will make it possible to quickly heat a liquid that has been brought up to a high pressure.

The purpose of the present invention is to satisfy this need.

To achieve this, this invention proposes a boiler for use on a machine for preparing drinks comprising a diffuser having a first wall to be placed in contact with the fluid to be heated, a second wall opposite the first wall equipped with at least one heating element, at least one body defining, with the first wall of the diffuser, at least one heating chamber, wherein the heating element is a screen-printed or photo-engraved resistance or any other film-type of resistance. The boiler is equipped with support means arranged to bear on one part of least of the perimeter of the second wall. The boiler has a deformation chamber. The boiler is arranged so that when operating, and subjected to the pressure inside the heating chamber that is typically between 8 and 25 bars, the diffuser elastically deforms in the deformation chamber so as to at least partially absorb the pressure force.

Therefore, the invention allows elastic deformation and penetration of the diffuser inside the deformation chamber under the effect of the pressure. The pressure force is not therefore transmitted, at least totally, to a part of the boiler. This prevents the creation of a zone subjected to high stress. The diffuser absorbs a substantial part of the pressure force generated by the pressurised fluid.

Moreover, the diffuser need not be particularly rigid or very thick. Therefore, its thermal inertia is limited.

Therefore, the invention proposes a boiler that can withstand high pressure, typically at least 8 bars, while achieving shorter heating times.

Optionally, but nevertheless advantageously, the invention may possess any one of the following characteristics:
the boiler is arranged to withstand the pressure of the fluid inside the boiler that easily exceeds 10 bars and will preferably reach 25 bars in the heating chamber.
advantageously, the boiler is formed so that when operating, the pressure in the heating chamber is between 8 and 25 bars and preferably between 8 and 20 bars.
the diffuser and the deformation chamber are formed so that when pressurised the diffuser deforms without interfering with a part of the boiler whose rigidity is greater than that of the diffuser. To achieve this, the diffuser and the deformation chamber are formed so that the diffuser deforms without interfering with a boiler device. The diffuser may also be arranged so that it comes into contact with a compressible material or fluid such as a gas or an elastomer.
according to one alternative, the diffuser may be arranged so that it can deform freely in a first phase so as to absorb part of the pressure force as in the second phase it comes into contact with one part of the boiler to which it transmits part of the residual pressure force.
the boiler has at least two diffusers, the second walls of which are arranged so as to mutually face one another.
the diffusers enclose the support means.
the boiler is symmetrical relative to the mid-plane between the two diffusers. The part of the pressure force that is transmitted to the support means balances at the level of the support means.
the diffuser has an area of between 2000 and 9000 mm² and more advantageously between 2500 and 8000 mm².
the diffuser is between 0.3 and 4 mm thick and more advantageously between 0.5 and 2.5 mm. In an advantageous arrangement, to reduce the thermal inertia and increase the rate of heating, this thickness is between 0.5 and 1.5 mm.
the deformation chamber in the zone of maximum deformation of the diffuser is between 0.3 and 2 mm deep and more advantageously between 0.3 and 1 mm deep.
the surface of the diffuser, which is able to deform freely under the force of the pressure, represents more than 60%, and advantageously more than 70%, and even more advantageously more than 80% of the total area of the diffuser. The remaining area is maintained by support means and defines the diffuser perimeter. In a preferred arrangement, the deformation chamber has an area of between 60 and 95% of the diffuser area.
diffuser deformation is static.
the contact between the support means and the diffuser, together with the elasticity of the diffuser, are configured so that the diffuser deforms without being raised to the level of the support means.
the device comprises a support that acts as the frame accommodating the support means.
the support means define the support. In an alternative arrangement, the support is separate from the support means.
the support has cavity that defines the deformation chamber.
the cavity may be openwork. In an alternative arrangement, it is closed relative to the outside of the boiler. It can be made tight.
the support and the support means form a single part.
the boiler has at least two diffusers that are turned to mutually face one another and enclose the support means.
according to one embodiment, the heating chamber is positioned on the periphery of the heating means and the heating means are positioned on the periphery of the support means.
   According to another embodiment, the heating means are positioned on the periphery of the heating chamber and the support means are positioned on the periphery of the heating means so is to enclose them.
the diffuser is appreciably flat. The invention with this type of diffuser is particularly advantageous since other inventions have very limited capacity to withstand pressure.
   According to one embodiment, the heating means are roughly cylindrical. The section of the diffusers may therefore be roughly circular on the cylinder axis or the section of the diffusers on the cylinder axis may have a form that is appreciably polygonal and preferably square.
the support has at least a first zone in which the support means are situated and which is designed to receive the diffuser and at least one second zone situated at the periphery of the first zone and through which the body is designed to be joined to the support,
the support is symmetrical relative to a mid-plane,
the boiler is symmetrical relative to a mid-plane,
it is equipped with two diffusers; the support means are positioned between the two walls of each one of the diffusers,
the boiler is arranged so that the liquid under pressure is arranged on either side of the support means to enable the forces generated by the pressure of the liquid to be transmitted to the support means and be balanced at the support means. Thus, the forces generated by the pressure are transmitted to the body.

The invention also concerns a machine for preparing beverages such as a coffee machine including a boiler with any one of the preceding characteristics. This machine has a pump that is designed to increase the pressure of the liquid before it is introduced into the boiler.

Other characteristics, aims and advantages of the present invention will come to light on reading the following detailed description and taking into account the appended drawings given as non-exhaustive examples and on which:

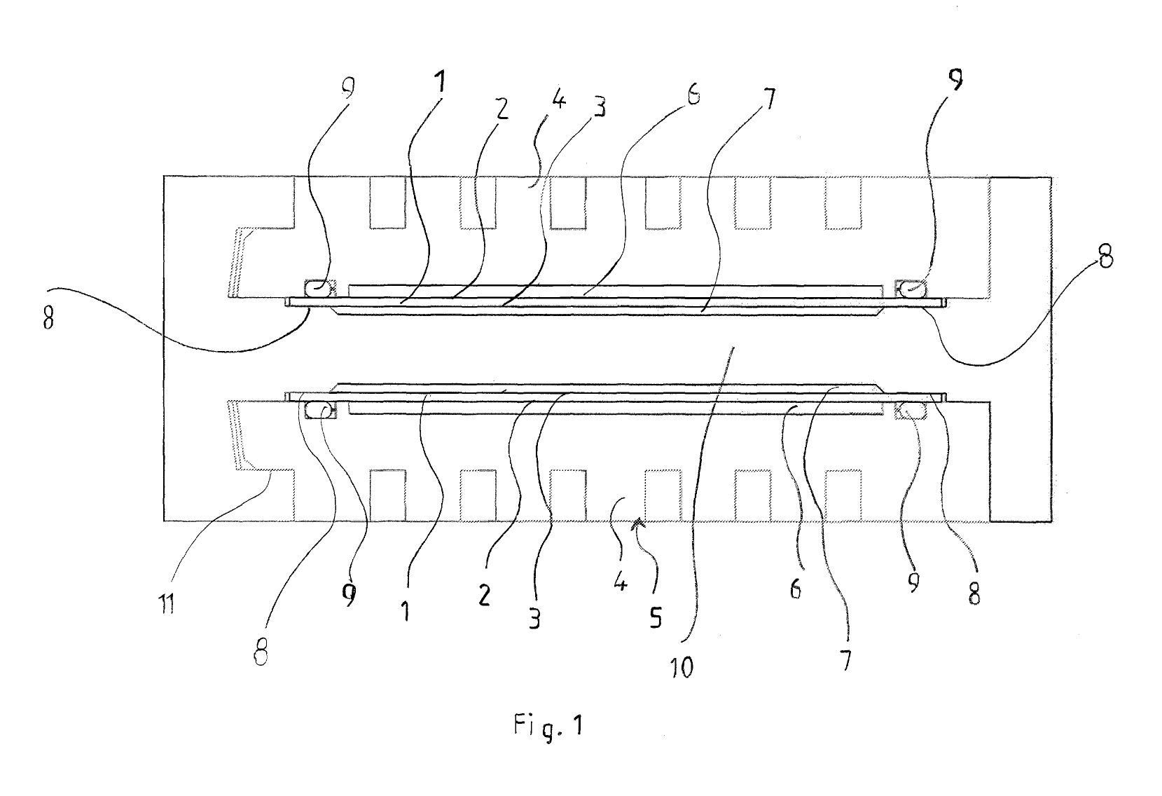

FIG. 1 is a sectional view of the boiler according to one embodiment of the invention in which the diffuser is not subjected to a high pressure force.

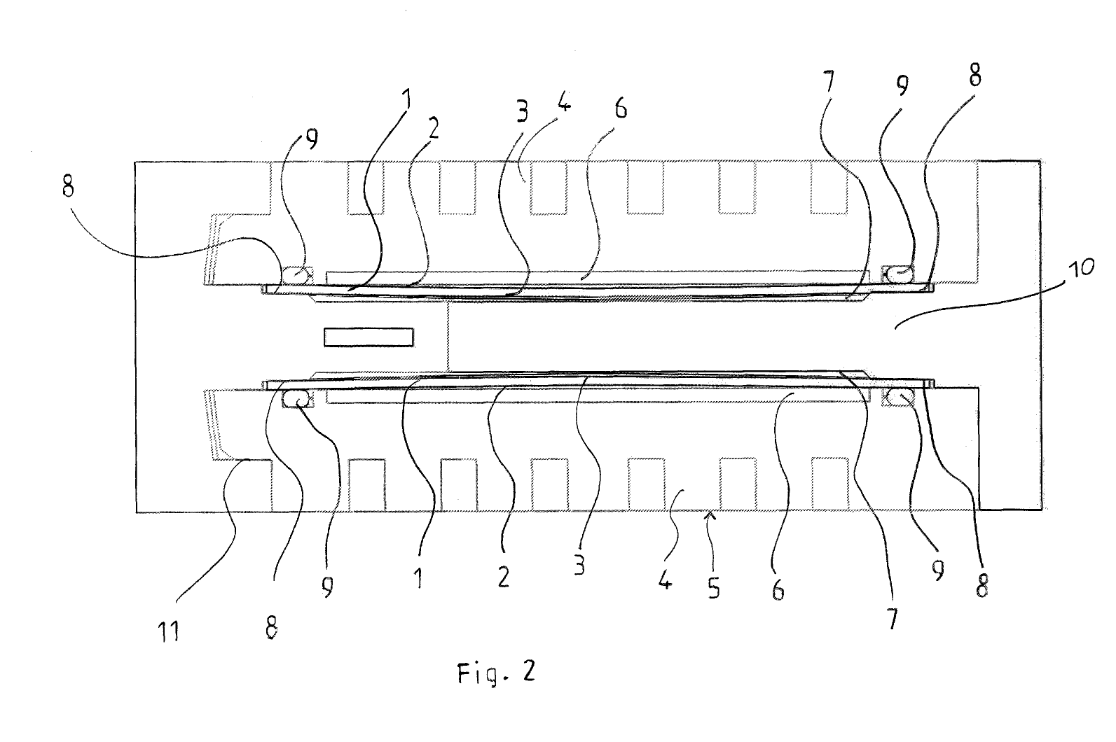

FIG. 2 is a sectional view of the boiler illustrated in FIG. 1 in which the diffuser is subjected to a high pressure force.

The boiler consists of a body 5 and the heating means forming a heating volume with body 5 within which a liquid flows and is heated. More particularly, the heating means have at least a diffuser 1 comprising a first wall 2 designed to come into contact with the liquid to be heated. First wall 2 is designed to bear on an internal face of body 5 in order to define the heating chamber.

In the example shown, the heating volume defines a coil-shaped circulation channel 6. The sectional view of this channel 6 shows for instance two cross walls and two side walls. A first cross wall 2 is supported by first wall 2 of diffuser 1 and a second cross wall 3 is supported by the inner face of body 5. The sidewalls are supported by body 5 and extend in the direction of diffuser 1. On FIGS. 1 and 2, the channel section is lengthwise.

In a non-illustrated variant of the embodiment, the sidewalls are supported by diffuser 1. In this variant, diffuser 1 has more material than in the previous variant. The sidewalls increase the contact surface between diffuser 1 and the liquid. This favours thermal exchange.

The heating means have at least one heating element arranged on second wall 3 of diffuser 1, second wall 3 being opposite first wall 2. In an advantageous arrangement, this heating element consists of a film type resistance with high power density. It is obtained for instance by screen-printing or photo-engraving using a resistance type ink. It can be the so-called thick film ink, or of the printed circuit type. This heating component is suitable for FTH (Flow Through Heater) type boilers whose particularity is that their heating element transmits the heat almost directly to the fluid as this moves along the circulation channel. For reasons of clarity, only screen-printed resistances will be referred to in the remainder of this description. In each of the embodiments described hereafter, the screen-printed resistance may be replaced by a photo-engraved resistance or by any other film-type resistance with high power density.

The screen-printed resistance has least one track forming a pattern on second wall 3. The resistance has a screen-printed track or several tracks forming a pattern. As an example, this pattern may form a coil, a spiral, an assembly of concentric or juxtaposed circles, or take on any other form.

When electricity is supplied to serigraphed resistance 1, it generates heat which is transmitted to diffuser 1 then to the liquid in the heating chamber. In a preferred arrangement the heating chamber forms a circulation channel and the boiler subject of the present invention is a “Flow through Heater” type described above.

For example, serigraphed resistance 1300 may have a thermal power of between 1300 W and 2500 W, and more especially around 1800 to 2200 W. The purpose of diffuser 1 is to act as backing receiving the screen-printed resistance and ensuring satisfactory thermal diffusion between the screen-printed resistance and the liquid. Advantageously, first wall 2 receives a food quality lining.

In a particularly advantageous arrangement, the boiler has 8 support means arranged to bear on second wall 3 of diffuser 1. These support means 8 tend to maintain diffuser 1 in contact with body 5.

Characteristically, the boiler is equipped with a deformation chamber 7. This chamber is positioned relative to the heating chamber at the rear of second wall 3 of diffuser 1.

The boiler is arranged so that under the effect of the pressure force generated by the fluid present in the heating chamber, diffuser 1 deforms elastically in deformation chamber 7. The boiler is configured so that this deformation of diffuser 1 absorbs all or at least a significant part of the pressure force. This deformation is essentially static. It occurs as the pressure in the boiler builds up. It then stabilises. As the pressure falls, the diffuser takes up its initial shape and position.

The deformation of diffuser 1 is illustrated in FIG. 2. On this figure, diffuser 1 forms a plate which bends as it penetrates deformation chamber 7.

This deformation of diffuser 1 enables the boiler to withstand high pressures without requiring that diffuser 1 is particularly rigid or very thick. This enables the invention to withstand the thickness and therefore the inertia of diffuser 1. Consequently, it makes it possible to obtain pressurised hot water in a short time. As the thermal inertia of the boiler is reduced, the efficiency of the latter is improved. In an advantageous arrangement, diffuser 1 has a thermal conductivity that is above or equal to 10 W/m/K and more particularly between 10 W/m/K and 400 W/m/K. The transmission of heat between the resistance and the liquid is favoured by this type of diffuser 1.

Moreover, the invention makes it possible to do without complex and bulky devices able to withstand the pressure forces applied to diffuser 1. Therefore, the advantage of the invention is to limit the size of the boiler.

The depth of the boiler will be adapted so as to allow sufficient deformation of diffuser 1 so that it absorbs a more or less significant part of the pressure force. Generally the depth of deformation chamber 7 is taken as the dimension of this chamber in an appreciably normal line direction relative to diffuser 1.

Deformation chamber 7 is also shaped so that the heating element does not interfere with the walls of deformation chamber 7 when the diffuser deforms. In particular, when the heating element consists of a screen-printed resistance with tracks arranged opposite deformation chamber 7, the said deformation chamber 7 will be designed sufficiently deep so as to avoid any electrical contact.

Moreover, deformation chamber 7 limits the transmission of heat by conduction between diffuser 1 and the other boiler devices. The invention therefore enhances the thermal insulation of diffuser 1. This improves boiler efficiency.

Diffuser 1 is designed to be elastic, especially with good flexural elasticity and good thermal diffusivity. To this end, diffuser 1 is essentially made of metal: steel, stainless steel, aluminium, enamelled or brass-based steel.

According to a favoured embodiment, deformation chamber 7 and diffuser 1 are shaped so that diffuser 1 deforms freely inside deformation chamber 7 without interfering with any part of the boiler whose rigidity is greater than that of diffuser 1. The latter therefore absorbs almost all the pressure forces.

Therefore, diffuser 1 will not interact with any part of the boiler when it penetrates and deforms elastically inside the diffusion chamber. To this end, the diffusion chamber may be filled with air not contained in the latter. This improves and increases the overall efficiency of the hot parts of the boiler.

Therefore, it can also be said that diffuser 1 interacts with a compressible element in deformation chamber 7. This element may consist of a gas confined within the chamber which has been rendered appreciably tight or an elastomer type material such as silicone rubber that is able to withstand a high-temperature and/or has received an insulating liner on its face opposite the heating elements, etc. This latter variant enables the pressure force to be distributed uniformly on diffuser 1. This prevents deformation of the latter to such an extent that diffuser 1 largely absorbs the pressure force. As to the compressible element, this absorbs the residual part of the pressure force that has not been absorbed by diffuser 1. This variant has an advantage in terms of safety in that it avoids any risk of deformation of diffuser 1 beyond its elasticity threshold. This variant helps to reinforce the boiler's insulation by choosing a permanently and electrically isolating compressible element. This improves the boiler's safety and efficiency.

According to another embodiment, the boiler is arranged so that diffuser 1 is able to deform elastically inside deformation chamber 7 thereby absorbing a large part of the force generated by the pressure until it comes into contact with a rigid element whose rigidity is greater than that of diffuser 1. Diffuser 1 then transmits the residual pressure force that has not been absorbed by diffuser 1 to this rigid component. This residual part is notably less than the part absorbed by diffuser 1. A thermally and electrically isolated material will be preferred for this rigid component.

The depth of deformation chamber 7 will be determined for each of these embodiments in relation to the pressure force generated by the fluid and the rigidity of diffuser 1 in particular.

The boiler is arranged so that when the pressure force disappears elasticity causes diffuser 1 to return to its rest position.

In a preferred arrangement, support means 8 define a contact on the perimeter of second wall 3 of diffuser 1. Support means 8 are able to apply a continuous or discontinuous contact in the form of, for instance, a series of punctual contacts on diffuser 1.

Advantageously, the surface of diffuser 1 in contact with support means 8 is less than 40%, and more advantageously 30%, and even more advantageously 20% of the total area of diffuser 1. Therefore, the surface of diffuser 1 that is able to deform in order to absorb the pressure force is much greater than the surface of diffuser 1 maintained in contact with body 5 by support means 8.

Advantageously, the boiler has a peripheral gasket 9 positioned between body 5 and diffuser 1. This gasket 9 encloses the heating chamber so as to ensure that the latter is tight. For this purpose, a groove in body 5 is used to house gasket 9. Diffuser 1 is fitted on body 5 with support means 8 providing a perfect contact between peripheral gasket 9 and diffuser 1. As a result, gasket 9 remains in contact with diffuser 1 and body 5, thereby ensuring the tightness of the heating chamber whatever the pressure of liquid applied on diffuser 1.

Deformation chamber 7 has a heating element. It is insulated from water. Advantageously, diffuser 1 is formed so that even when it is deformed the contact between gasket 9 and diffuser 1 is neither broken nor damaged. Similarly, the contact between support 10 and first wall 2 of diffuser 1 is also retained during the deformation process. For this purpose, diffuser 1 is designed to be sufficiently flexible to deform and marry the walls of flange 4 and support 10 without lifting up. The complementary forms of body 5 and support 4 are also arranged so as to maintain this contact. In particular, the dimensions of support means 8 would be sufficient to ensure that diffuser 1 is well held in position. Moreover, the upstand formed by the groove and turned towards the deformation chamber contributes to ensuring that the diffuser is applied against both support means 8 of body 5 and support 4. Therefore, the boiler is arranged so that the insulation of heating chamber 6 and the insulation of deformation chamber 7 are kept intact, even under the force generated by the high-pressure inside heating chamber 6. The electrical parts of the heating element are thereby insulated electrically from the fluid whatever the phase of use.

Advantageously, the boiler has a support 10 in which is defined deformation chamber 7.

Advantageously, support 10 incorporates support means 8. In an alternative arrangement, support means 8 are separated from support 10 and co-act with the latter.

Advantageously, support means 8 are arranged so that the pressure force applied on diffuser 1 by the fluid is not, or is only slightly transmitted onto support means 8. Therefore, most of the pressure force is applied onto the surface of diffuser 1 that is designed to deform. To this end, support means 8 may be arranged on the periphery of the surface of diffuser 1 defining the heating chamber.

In a preferred arrangement, the boiler is equipped with the means for absorbing force 11 arranged so as to co-act with support means 8 and body 5 so that the force applying diffuser 1 onto body 5 at support means 8 is satisfactorily transmitted.

According to the variant of the embodiment illustrated, support 10 is designed to incorporate these means for absorbing force 11. According to another variant of the embodiment not illustrated, body 5 incorporates the means for absorbing force 11. Accorded to another variant, means 11 for absorbing the pressure force are independent from support 10 and body 5 and are arranged so as to co-act with the latter.

Deformation chamber 7 may be designed to be tight when closed. In this type of embodiment as illustrated, diffuser 1 cannot be accessed through deformation chamber 7. In another embodiment, deformation chamber 7 may be a partially or totally openwork structure thereby creating a passage allowing access to diffuser 1.

As on the example illustrated, diffuser 1 may be plate-shaped. The invention is particularly advantageous for these types of diffuser 1 since a plate has only slight resistance to pressure. Diffuser 1 may also be designed with an appreciably cylindrical or part-cylindrical shape. Deformation chamber 7 can also have a cylindrical or part-cylindrical shape.

In the non-restrictive example shown on the figures, the boiler has two diffusers 1, each one of second walls 3 being turned to face one another. Each diffuser 1 is associated with a body 5. Diffusers 1 define the heating chambers that constitute a common assembly defining a same heating volume. Each of the second walls is equipped with at least one screen-printed resistance.

Thus, the screen-printed resistances are enclosed inside the heating volume. The latter is arranged on either side of the assembly formed by diffusers 1. This leads to less heat loss between the boiler and its environment and this improves the thermal efficiency of the boiler.

In the example illustrated on the figures, the boiler has a support 9 that is common to the two diffusers 1. Support 10 defines two deformation chambers turned respectively towards second wall 3 of one of diffusers 1. Advantageously, support 10 has two peripheral zones arranged respectively on the periphery of one of the deformation chambers. These peripheral zones form support means 8 designed to bear on second wall 3 of each of the diffusers 1 in order to apply the latter against body 5.

The peripheral zones of support 10 are also designed to co-act with body 5 in order to ensure correct positioning of the latter relative to support 10. In the example illustrated, body 5 consists of two flanges 4 each one designed to be associated with a diffuser 1 in order to define the heating chamber. Each flanges 4 has an outer face and an inner face the surround of which bears on the peripheral zone of support 10. The preferred material will be plastic.

The boiler has movable fixing means arranged to allow removable separation and joining of flange 4 on support 9.

As an illustration, a boiler according to the example described above has the following characteristics:
diffuser of around 60 cm2 and 1 mm thick.
stainless steel diffuser
11 cm2 diffuser area in contact with support means 11,
diffuser area designed to deform: 49 cm2
total diffuser area: 60 cm2
the deformation chamber has an area of between 75% and 85% of the diffuser area.
the depth of the deformation chamber is around 1 mm.
around 1000 W.
boiler thickness of approximately 40 mm
appreciably square external shape measuring approximately 100 mm per side

This boiler can easily raise 8 cm³ of water from 20° C. to 95° C. in less than 2 seconds.

These dimensions of diffuser 1 and deformation chamber 7 ensure that a good flow of hot water under pressure is quickly available. They ensure that the size remains small while retaining the capacity to withstand the pressure. Indeed, with this boiler configuration, the greater depth of the deformation chambers renders the assembly less sturdy.

Support 10 includes fluid connection means arranged to ensure that the liquid flows into and out of the heating chamber. The boiler is also equipped with electrical connection means arranged to come into contact with complementary electrical connection means joined to the machine for preparing beverages in order to supply the boiler with electricity and in particular the heating elements.

According to another embodiment not illustrated, the body is cylindrical, circular or polygonal. The diffusers are housed inside the body. They are appreciably cylindrical and have a section that appreciably complements that of the body. Thus, the body acts as a sleeve around the diffusers. The heating volume is positioned on either side of the diffusers and encloses the screen-printed resistance.

According to an embodiment not shown, the boiler may be equipped with a single heating chamber. Therefore it may be equipped with only a single flat or curved diffuser. A single deformation chamber is then sufficient. In a typical arrangement, such a boiler may be appreciably similar to one half of the boiler illustrated on FIGS. 1 and 2, the half being defined by a section according to a normal plane on the sheet and passing through the middle of the illustrated boiler.

A same diffuser may be equipped with one or several screen-printed resistances.

Several diffusers arranged so as to form a cylinder may also be used.

In each of these embodiments, the channel sidewalls may be supported either by the diffuser or by the body.

For a diffuser with cylindrical shape, the sealing means consist of two gaskets with section that is appreciably identical to that of the diffuser and installed along the cylinder axis on either side of the heating chambers.

A boiler according to the invention has very thin diffusers. This means that it uses a very small quantity of metal. This enables the invention to limit the weight of the boiler and to reduce the costs of material and transport induced by the use of the metal. In fact, there is a particularly high transport cost in an eco-design context since it is intended for the boiler to be separated from the remainder of the equipment in order to be sent to a maintenance centre during its service life. Moreover, the thermal inertia of the boiler is considerably limited.

The present invention is not limited to the embodiment described above but extends to any embodiment that conforms to its spirit.

### REFERENCES

1. Diffuser

2. First wall

3. Second wall

4. Flange

5. Body

6. Circulation channel

7. Deformation chamber

8. Support means

9. Gasket

10. Support

11. Pressure force absorption means

1. Boiler for a machine for preparing beverages wherein a fluid is brought to a pressure of at least 8 bars and comprising:
at least a diffuser (1) comprising a first wall (2) designed to come into contact with the liquid to be heated, a second wall (3) opposite the first wall (2) equipped with at least one heating element,
at least one body (5) defining with first wall (2) of diffuser (1) at least one heating chamber,
characterised in that the heating element consists of a resistant type film and that the boiler consists of a deformation chamber (7) and is arranged so that under the effect of the pressure inside the heating chamber, the diffuser (1) deforms elastically within deformation chamber (7) in order to absorb at least part of the pressure force.

2. Boiler according to claim 1 in which diffuser (1) and the deformation chamber (7) are formed so that when pressurised diffuser (1) deforms without interfering with a part of the boiler whose rigidity is greater than that of the diffuser (1).

3. Boiler according to claim 1 in which the deformation chamber (7) contains a fluid or compressible material.

4. Boiler according to claim 1 comprising at least two diffusers (1) whose second walls (3) are turned mutually towards one another.

5. Boiler according to claim 4 equipped with support means (8) arranged to bear on one part at least of the surround of second wall (3) and in which diffusers (1) enclose support means (8).

6. Boiler according to claim 4 in which the boiler is symmetrical on a mid-plane situated between the two diffusers (1).

7. Boiler according to claim 5 in which support means (8) define or co-act with a support (10), having a cavity defining the deformation chamber (7).

8. Boiler according to claim 7 in which support (10) under support means (8) constitute a single part.

9. Boiler according to claim 8 in which diffuser (1) has a plate-like form.

10. Boiler according to claim 1 in which at least one diffuser (1) with an appreciably cylindrical shape and in which the heating chamber is situated on the periphery of the heating element, the heating element being situated on the periphery of support means (8) or in which the heating element is situated on the periphery of the heating chamber, support means (8) being situated on the periphery of heating element so as to enclose the latter.

11. Boiler according to claim 1 in which at least one diffuser (1) has a shape essentially cylindrical.

12. Boiler according to claim 1 in which diffuser (1) has an area of between 2000 and 9000 mm², and more advantageously between 2500 and 8000 mm².

13. Boiler according to claim 1 in which diffuser (1) has a thickness of between 0.3 and 4 mm, and more advantageously between 0.5 and 2.5 mm and even more advantageously between 0.5 and 1.5 mm.

14. Boiler according to claim 1 in which deformation chamber (7), in a zone of maximum deformation of diffuser (1), is between 0.3 and 1.5 mm deep and more advantageously between 0.3 and 1 mm deep.

15. Coffee machine for preparing hot drinks equipped with a boiler according to claim 1.
